(19) United States
(12) Patent Application Publication
(10) Pub. No.: US 2014/0030980 A1
(43) Pub. Date: Jan. 30, 2014

(54) MOBILE USER CONTENT SHARING APPLICATION

(71) Applicant: Mark D'Ambrosio, Scottsdale, AZ (US)

(72) Inventor: Mark D'Ambrosio, Scottsdale, AZ (US)

(21) Appl. No.: 13/952,314

(22) Filed: Jul. 26, 2013

Related U.S. Application Data
(60) Provisional application No. 61/676,175, filed on Jul. 26, 2012.

(51) Int. Cl. H04W 76/02

(52) U.S. Cl. CPC H04W 76/02
USPC 455/41.3

(57) ABSTRACT

A system and method for a first user to share user content from a first mobile device with a second user of a second mobile device, including inviting, by the first mobile device, the second mobile device to communicate with the first mobile device. In response to receiving an acceptance from the second user of the second mobile device, a communications link may be established between the first and second mobile devices. The first mobile device may be established as a presenter and the second mobile device may be established as a viewer. The user content may be communicated as directed by the first mobile device for substantially synchronously displaying the user content on the second mobile device. Responsive to the first user altering display of the user content on the first mobile device, display of the user content may be substantially synchronously altering on the second mobile device.

### RELATED APPLICATIONS

This Application claims priority to co-pending U.S. Provisional Patent Application Ser. No. 61/676,175, filed Jul. 26, 2012, the contents of which are hereby incorporated by reference in their entirety.

### BACKGROUND

Mobile devices, such as smart phones and tablets, have provided users with unprecedented functionality, both provided by hardware and software. As an example of the hardware, mobile devices are typically configured with camera and video functionality, global positioning functionality, and so forth. On the software side, mobile devices are typically capable of downloading mobile applications that are capable of using the hardware of the mobile devices and perform a virtually unlimited number of functions.

As an example of an application that is generally available on conventional mobile devices and common for people to use is a playback feature for a user to view photographs and videos (user generated digital content or user content) recorded by the user. A typical use of such a feature is a user showing his or her friends, family, and sometimes new acquaintances the user content on his or her mobile device either directly on the mobile device, communicating the user content to a device of another person, or uploading the user content to an online location (e.g., Facebook™) for another person to view the user content.

Despite mobile applications being relatively easy to perform these various user content sharing functions, certain problems and inconveniences exist with each For example, with a user showing user content to others in person, especially when sitting at a table, the mobile device is generally passed to the other person. As is often considered, however, relinquishing physical control of a mobile device is uncomfortable as a user may have certain user content that he or she does not want to share with the other person. Communicating the user content to another mobile device by email, messaging, or otherwise, can be cumbersome and provides a digital copy to the receiver of the user content, which may be undesirable to the sender of the user content. Posting the content to an accessible site may also be cumbersome because another user has to locate the site and, in many cases, has the ability to copy the user content. Also, if the user content is to be limited for access to a user's closest friend or family members only, posting to a public site or even a site that is invite only allows anyone else invited to that site also to have access to the posted user content.

### SUMMARY

The principles of the present invention overcome the shortcomings of conventional sharing of user content via mobile devices. In one embodiment, a first user of a first mobile device is able to share user content with a second user of a second mobile device by the first user inviting the second user to communicate via the first and second mobile devices. In response to receiving an acceptance from the second user of the second mobile device, a communication link between the first and second mobile devices may be established. In one embodiment, the first mobile device may be established as a presenter and the second mobile device may be established as a viewer. That is, the presenter may be a “master” and the viewer may be a “slave,” as understood in the art. The user content stored on the first mobile device may be communicated from the first mobile device to the second mobile device for substantially synchronously displaying on the second mobile device. A response to the first user altering display of the user content on the first mobile device, the user content being displayed on the second mobile device may be substantially synchronously altered, as well. As an example, if a first user zooms into a photograph on his or her mobile device, the user content on the second user's mobile device may automatically be zoomed into the photograph as is being displayed on the first user's mobile device.

A system and method for a first user to share user content from a first mobile device with a second user of a second mobile device, may include inviting, by the first mobile device, the second mobile device to communicate with the first mobile device. In response to receiving an acceptance from the second user of the second mobile device, a communications link may be established between the first and second mobile devices. The first mobile device may be established as a presenter and the second mobile device may be established as a viewer. The user content may be communicated as directed by the first mobile device for substantially synchronously displaying the user content on the second mobile device. Responsive to the first user altering display of the user content on the first mobile device, display of the user content may be substantially synchronously altering on the second mobile device.

### BRIEF DESCRIPTION OF THE DRAWINGS

FIG. 1 is an illustration of an illustrative environment, such as a restaurant or bar, in which individuals generally sit around a table to eat, drink, share conversation, and more recently, share digital content on or remotely located from their mobile devices;

FIG. 2A is an illustrative network environment in which a server located on a network is configured to manage data communications for mobile devices on which a user content sharing app operates to enable users to share user content in accordance with the principles of the present invention;

FIG. 2B is a network environment in which mobile devices may operate user content to sharing apps and communicate locally, as opposed to communicating via a network and server operating on the network;

FIG. 3 is a flow diagram of an illustrative process in which geolocations of users using mobile devices may be tracked and users of the mobile devices may be associated based on one or more participants so that relative geolocations of the users that have been associated may be reported to the users;

FIG. 4A is an interactive diagram in which communications may be communicated between participates of the user content sharing app in accordance with the principles of the present invention;

FIG. 4B is an illustration of an illustrative environment in which users of a user content sharing app may identify that other users are local and share user content by one user with other users local to the user sharing the user content;

FIGS. 5-16 are illustrative screen shots from mobile devices that enable users to share user content in accordance with the principles of the present invention.

### DETAILED DESCRIPTION OF THE DRAWINGS

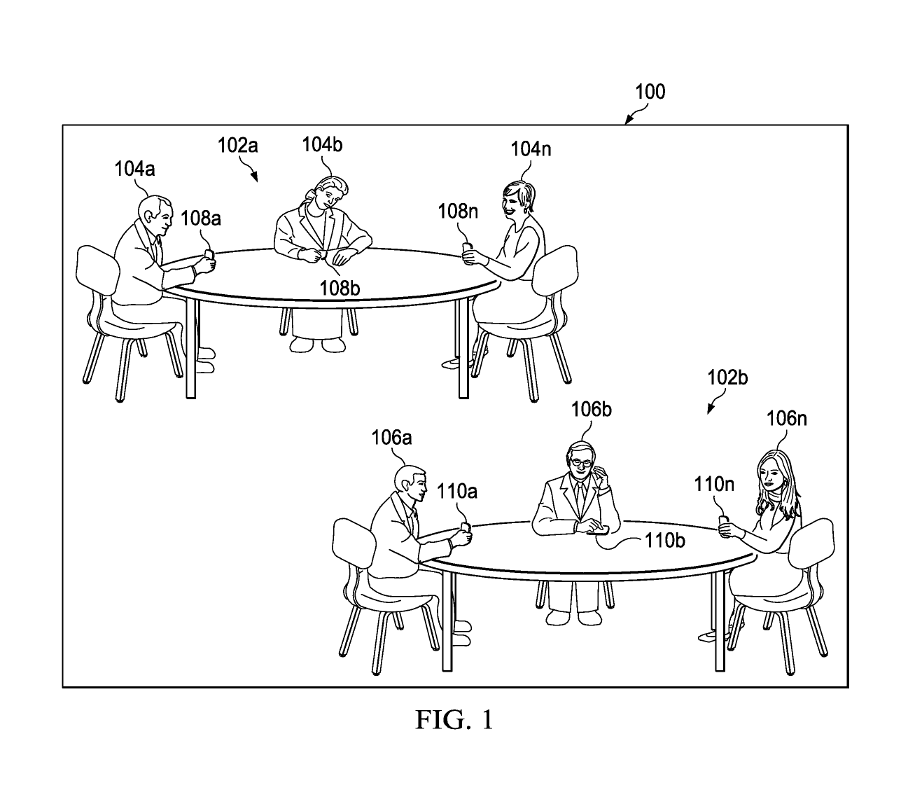

With regard to FIG. 1, an illustrative social environment 100 shows two groups 102a and 102b of people 104a-104n (collectively 104) and 106a-106n (collectively 106). Each of the groups 102a and 102b of people 104 and 106 have respective mobile devices 108a-108n and 110a-110n. The mobile devices may be smart telephones, tablets, personal computers, or otherwise that are capable of executing mobile apps, as understood in the art. In accordance with the principles of the present invention, one of the users in each of the groups may be established as a presenter of user content, as further described herein. In accordance with the principles of the present invention, the presenter may identify other local users of the sharing user content app by viewing a list of local users, as further described herein. However, there may be one or more techniques for a user's mobile device to be notified of other local users, including (i) receiving a communication from a server via a communications network that tracks geographical locations of other users who utilize the sharing user content app, (ii) receiving Bluetooth, WiFi, or any other local communications from other mobile devices within range of the respective local communications protocols, and/or (iii) using other communications technique, as understood in the art. Because the sharing user content app allows a user 104a to share user content on his or her mobile device 108a with mobile devices 108b-108n of other users 104b-104n in a sharing user content session, the user 104a does not have to physically pass his or her mobile device 108a to the other users 104b-104n in the group. It should be understood that the sharing user content app may be downloaded from a digital store or marketplace via a communications network, as understood in the art. The app may be free, have a nominal cost, have a per-session cost, have a cost-per-content amount, or utilize any other revenue model.

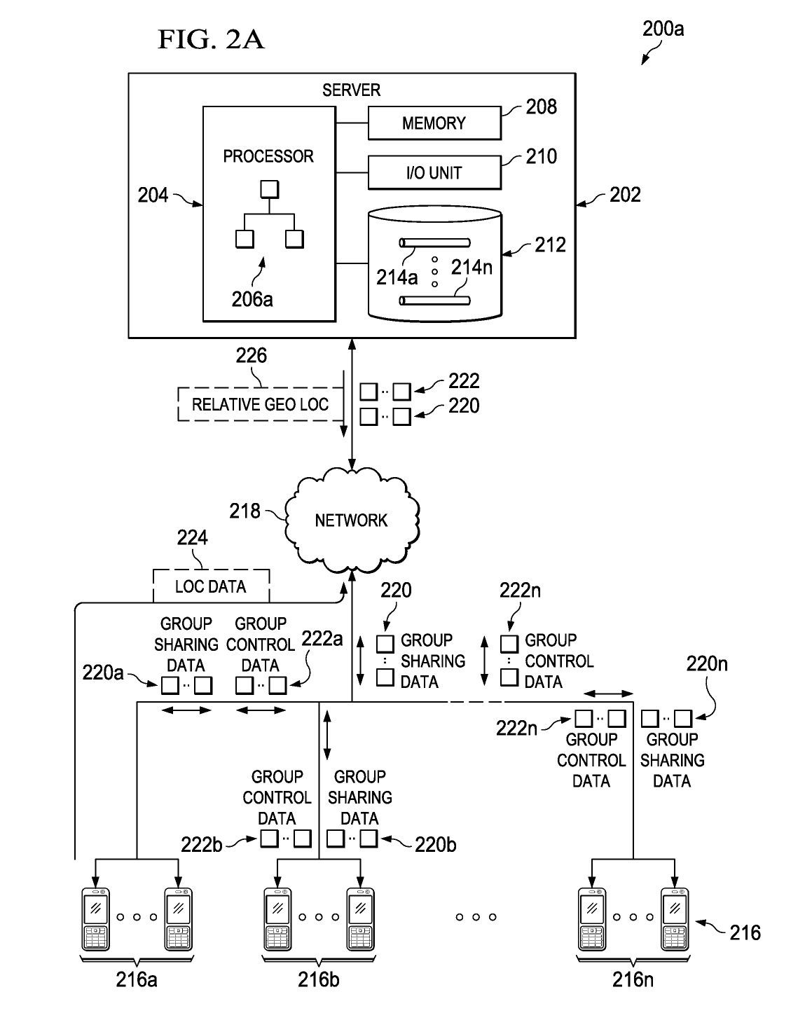

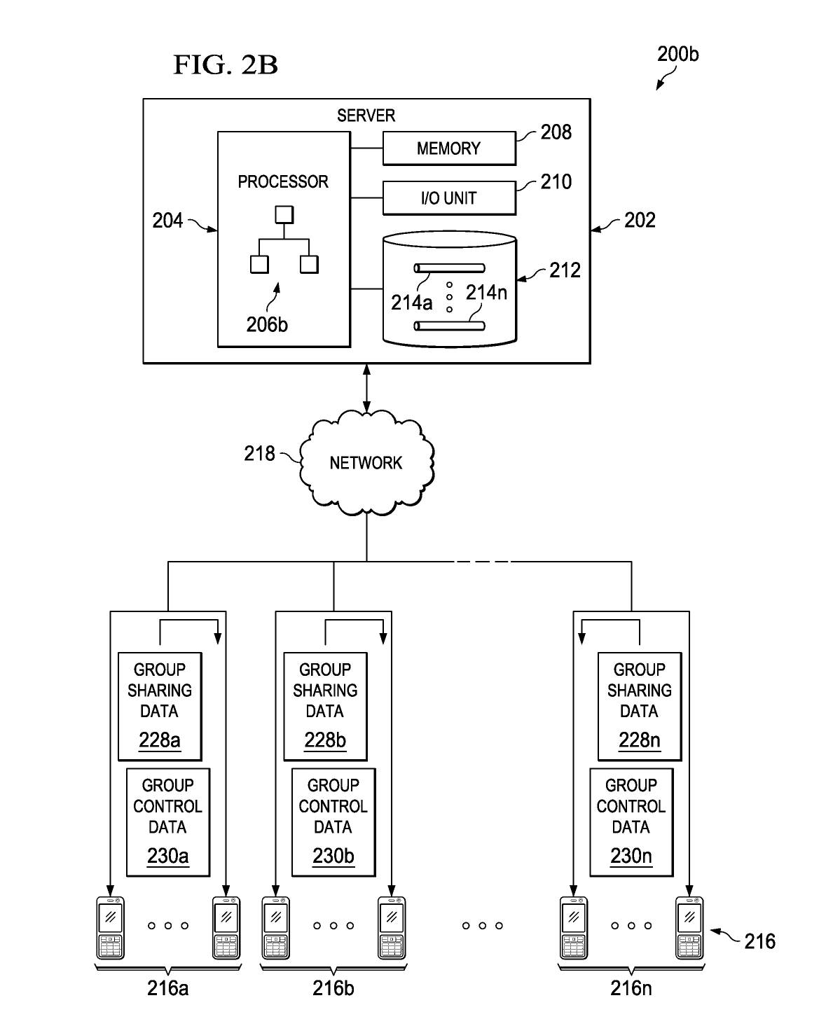

With regard to FIG. 2, an illustrative network environment 200a that is configured to provide for sharing of user content between mobile devices may include a server 202 that is configured to manage communications between users of the sharing user content app in accordance with the principles of the present invention. The server 202 may include a processing unit 204 that includes one or more computer processors that is configured to execute software 206a. The software 206a may be configured to provide for the functionality of tracking geographic location of users, establishing groups for user content sharing sessions, communicating the user content between or among mobile devices of users, and so on. The processing unit 204 may be in communication with a memory 208 that is configured to store data and/or software for execution by the processing unit 204, input/output (I/O) unit 210 that is configured to communicate commands and/or data remotely from the server 202, and storage unit 212 that is configured to store one or more data repositories 214a-214n (collectively 214). In one embodiment, the data repositories 214 may be configured to store geographic locations of users, associate friends, followers, etc. of users with each member of the sharing user content app community.

Users of the sharing user content app may have mobile devices 216 on which the sharing user content app resides. As shown, a number of different groups 216a-216n (collectively 216) are established by the users. It should be understood that not all users may be actively participating at any one time in a group. That is, a user with a mobile device on which the sharing user content app resides may not currently be in a group or active session in which users are sharing user content in a presenter-viewer mode.

In the configuration provided by the network environment 200a, the server 202 operates as a controller for the sharing user content apps executing on the mobile devices 216. In being the controller, group sharing data 220a-220n and group control data 222a-222n may be communicated via the network 218 to the server 202. In addition, each of the mobile devices may communicate location data 224 to the server 202. The server 202 may be configured to determine which users are within local proximity of one another to the resolution available by each of the mobile devices, as understood in the art, thereby enabling the server 202 to update each user with geographic proximity of users of the sharing user content app in response to determining relative geographic locations of the users. In one embodiment, the server 202 may communicate relative geographic locations to each of the mobile devices to notify each of the users relative proximity of other users of the sharing user content app. It should be understood that update of the relative geographic locations of other users may be performed using a “push” or “pull” communications model, as understood in the art.

With regard to FIG. 2B, a network environment 200b may utilize the same or analogous network configuration as shown in FIG. 2A, but the communications protocol and software for causing communications may be different from that of FIG. 2A. As shown in FIG. 2B, rather than the communications being performed with the server 202, the communications may be primarily local to each of the groups 216a-216n. In this embodiment, rather than the mobile devices communicating their respective geographic locations with the server 202 for associating with each of the other mobile devices, the mobile devices may check locally using Bluetooth, WiFi, or other local communications protocol to determine whether another mobile device that is using the sharing user content app is local and available to participate in a group session. If a mobile device identifies other mobile devices with the sharing user content app that are local, then the user of the mobile device may invite other local mobile devices and share group sharing data 228a and group control data 230a with the other local mobile devices. In one embodiment, a user may invite contacts, friends, or unknown locally identified users that may be listed in a local users listing for a presenter.

As described further herein with respect to FIGS. 2A and 2B, the group control data 230a may be set with parameter(s) that establish the inviting mobile device as the presenter and accepting mobile devices as viewers. Another parameter may enable the user of the presenter mobile device to limit viewer mobile devices from downloading or otherwise copying user content being shared by the user of the presenter mobile device. Because the configuration of FIG. 2B does not utilize communications to the server 202 for sharing control or user data, the mobile devices use local communications protocols and, therefore, do not utilize time or bandwidth of their communications service plan. Moreover, because the sharing user content app merely looks for any local mobile device with the sharing user content app, a user does not have to have previously established information about the other local users prior to identifying those other local users. This is true for both configurations in FIGS. 2B and 2A.

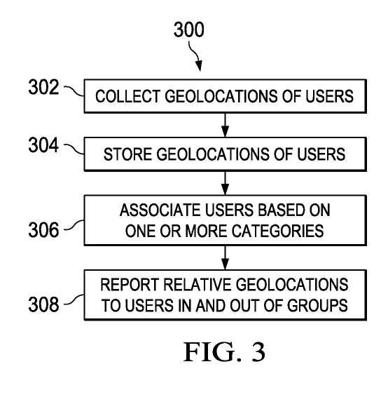

With regard to FIG. 3, a flow chart of an illustrative process for locating and notifying users of geographic proximity of other users of the sharing user content app may be performed. The process 300 starts at step 302, where geographic locations of users may be collected. In one embodiment, the collection may be performed by a server receiving global positioning system (GPS) locations of mobile devices of users. Alternatively, mobile devices themselves may look for other local mobile devices with the sharing user content app operating thereon by using local communications protocols, such as WiFi, Bluetooth, or otherwise. At step 304, geographic locations of users may be stored. The storage may be performed by storing each user location independent of one another and/or associating each user with other users of pre-established groups that each user has established. It should be understood that a pre-established group is different from an active group in which a user is actively sharing user content, as shown in FIGS. 1, 2A, 2B. In the case of mobile devices operating in the configuration of FIG. 2B, the mobile devices themselves may store the geolocations of users that are local to itself.

At step 306, users may be associated based on one or more categories. As previous described, the users may be associated based on pre-established groups. The categories may include friends, family, special friends, followers, those who a user is following, or any other category. As an example, if a user is at a restaurant, the system may associate users who are also currently at that restaurant based on geographic coordinates of the users. Alternatively, network access points (e.g., a particular wireless router) may be utilized to determine geographic location or relative/proximity location of users.

At step 308, relative geographic locations may be reported to the users in and out of groups. That is, a user who has established or pre-established groups of other users that are families, friends, acquaintances, or otherwise, that user may be notified that other users in his or her pre-established groups are local or not local to the user. In being local, a pre-established geographic proximity may be utilized, where the local geographic proximity may be set to ranges that are consistent with resolution of the technology being utilized (e.g., GPS, WiFi, Bluetooth, etc.). Reporting may include communicating information to a mobile device that can then be displayed to a user upon viewing the sharing user content app or upon request from the app.

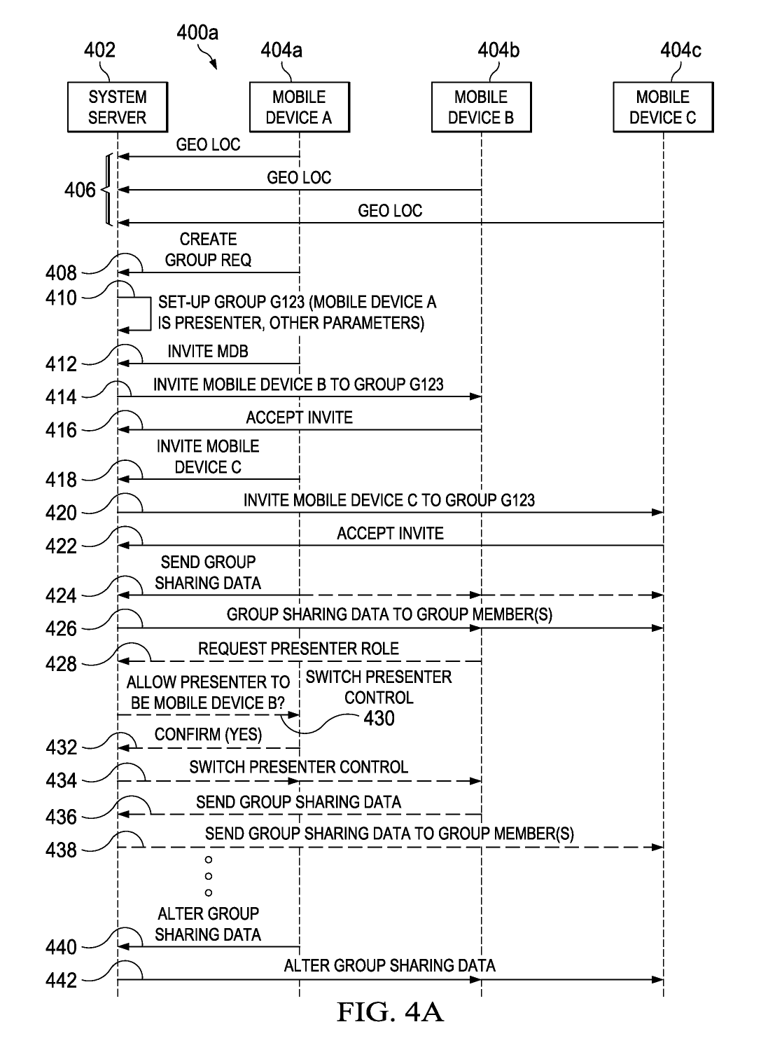

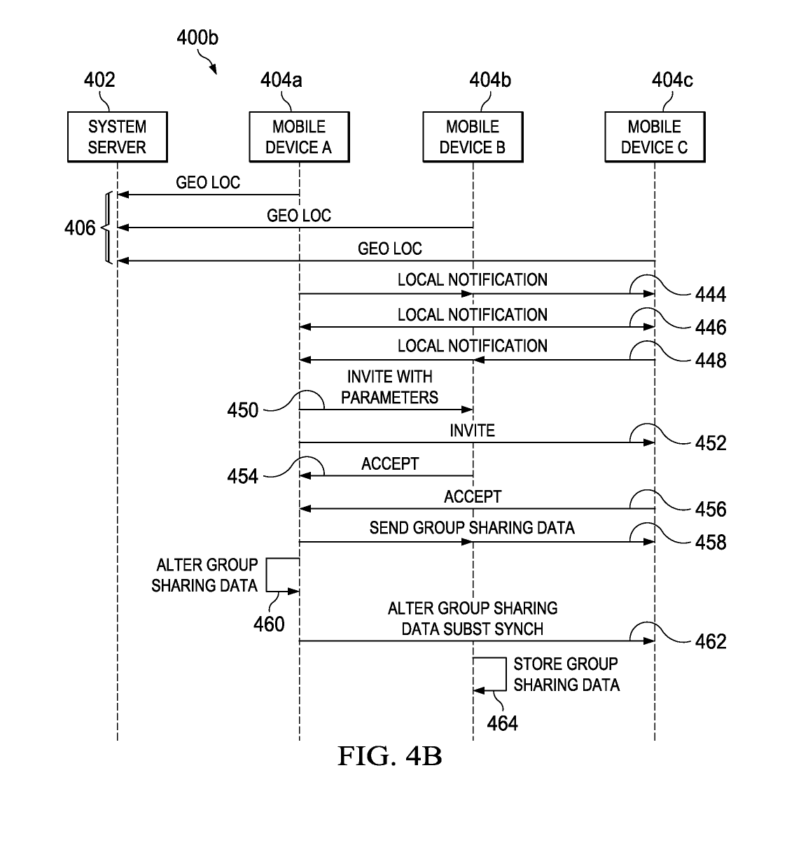

FIG. 4A, an interactive diagram 400 showing communications between a system server 402 located on a communications network, such as the Internet, and mobile devices 404a-404z is shown. At step 406, each of the mobile devices 404 may communicate geographic locations to the system server 402 for collection, storage, in association thereat. The geographic locations may be determined by GPS or other geolocating technologies, as understood in the art. At step 408, a user of mobile device 404a may submit a request to create a group to the system server 402. At step 410, the system server 402 may set up a group, such as group G123. In addition to submitting the request to create the group at step 408, the request may be submitted with certain parameters, such as (i) being a presenter, (ii) preventing other users of a group from become presenters, (iii) restricting downloading or copying of user content being presented, (iv) preventing viewers in the group from controlling viewing the user content in a different manner from that being presented, and (v) so forth. Other parameters may provide for:

(i) geo-location tagging of user content;

(ii) group event sessions;

(iii) meeting key for creating group sessions;

(iv) ability to text/chat with other users about the user content during a group session;

(v) establish privacy control (e.g., prevent other users from seeing one another, view-only);

(vi) block users from joining a group session;

(vii) allow other app integration (e.g., upload to Picasa, Twitter, Facebook, etc.) by entering login information;

(viii) “shake” to wake up app;

(ix) all one-at-a-time picture presentation or multi-select gallery feature;

(x) share user content from multiple sources;

(xi) add new user to contacts during group session;

(xii) anonymous share (e.g., family asks a user to take photo of their child at recital and send to them without exchanging contact information, such as phone number or email address);

(xiii) allow invitation of remote user(s) into group sharing session;

(xiv) record copy of presentation;

(xv) record audio (e.g., explanation) during presentation;

(xvi) communicate audio (e.g., music stored on mobile device) during presentation to viewers along with the user content (e.g., slide show of trip to Africa);

(xvii) allow for public chat room feature (e.g., sitting at a bar, take a photo, go into open chat room based on geo-location) to meet new friends and share photos;

Such parameters may be used to set up an app executing on a mobile device of a presenter and a mobile device of a viewer.

At step 412, the user of mobile device 404a may invite mobile device B (MDB) and communicate the invite to the system server 402, which, in turn, sends the invite to mobile device B to join group G123. The user of the mobile device 404b may accept the invite at step 416, which may be communicated to the system server 402. Although not shown, the system server 402, in response to receiving the acceptance of the invite from mobile device B, may add mobile device B to the group G123. At step 418, the user of mobile device A may send an invite for inviting mobile device C to the group G123. At step 420, the system server 402, in response to receiving the invite at step 418, may send the invite to mobile device C to join group G123. The invite may include a notification as to whether the user of mobile device A is in a pre-established group member of the user of mobile device C, for example. In step 422, the user of mobile device C may accept an invite and the mobile device 404c may communicate an acceptance to the system server 402, which, in turn, may add the mobile device 404c to the group G123 to enable the user of mobile device A to share user data with other members of the group G123. At step 424, the user of mobile device 404a may send group sharing data 424 to the system server 402, which, in turn, may communicate the group sharing data or user content to the group members, in this case users of mobile device B and mobile device C.

As also shown in FIG. 4A, rather than sending the group sharing data from mobile device A to the system server 402, mobile device A 404a may communicate the group sharing data or user content to mobile device B and mobile device C directly using a local communications protocol. Such a communications protocol or technique may be established by the user of mobile device A when creating the group by setting a communications parameter (e.g., communicate using a local communications protocol as opposed to communicating via a mobile or other communications network).

In one embodiment, if the user of mobile device 404a who set up the group G123 set a parameter that allows for other members of the group who are initially viewers to request or otherwise take over as presenters, then user of mobile device B may request a presenter role at step 428. At step 430, the system server 402, in response to receiving the request at step 428, may communicate a query to the user of mobile device A to allow the presenter role to be moved to mobile device B. If the user of the mobile device A confirms “yes” to the query at step 432, then at step 434, the system server 402 may switch the presenter control from mobile device A to mobile device B by informing both of the mobile devices of the switched role. At step 436, the mobile device B may send group sharing data or user content to the system server 402 for distribution to the other group members, now mobile device A and mobile device C or both viewers in the group G123. In an alternative embodiment, the presenter, such as mobile device A, may query another member in the group, such as mobile device B, to transfer the presenter role from the presenter to the other member. The other member may confirm acceptance of the presenter role. In one embodiment, the acceptance confirmation may be set to automatically accept the presenter role transfer query. Still yet, rather than querying, a command may be communicated between mobile devices to pass or take the presenter role without having to accept a query.

At step 440, assuming the user of mobile device A 404a is still the presenter, then, in response to the user of mobile device A altering the group sharing data or user content, such as by zooming in, changing images being viewed, or otherwise, the altered group sharing data may be communicated to the system server 402 at step 440. In response to the system server 402 receiving the altered group sharing data or user content, the system server 402 may communicate the altered group sharing data to the other members of group G123 at step 442. The altering of the group sharing data may be performed substantially simultaneously as the presenter (i.e., user of mobile device A) alters the group sharing data being viewed on the mobile device A.

With regard to FIG. 4B, an alternative system configuration in terms of communications is presented to enable mobile devices A, B, C in terms of determining local users of the sharing user content app and sharing user content. In one embodiment, geolocations of each of the mobile devices A, B, and C may be communicated to the system server 402 at step 406. By communicating the geolocations to the system server 402, the system server 402 may be configured to track geolocations of each of the mobile devices for a variety of different purposes, including, but not limited to, notifying each of the users of the mobile devices A, B, and C of locations of other users in their pre-established groups, for example. However, in accordance with a configuration provided in FIG. 4B, local communications may be performed, as well, to assist users in discovering or locating one another in a local venue, as further described herein.

At step 444, mobile device A may communicate a local notification to any other local mobile devices, such as mobile device B and mobile device C, using a local communications protocol, such as WiFi and/or Bluetooth. In addition, each of the mobile devices B and C may communicate local notifications at steps 446 and 448, respectively, to notify other mobile devices in their respective local vicinities. The apps (not shown) for sharing user content operating on each of the mobile devices 404 may notify users of the respective mobile devices that other users of the sharing user content app are local. At step 450, the user of mobile device A may communicate an invitation with parameters (e.g., presenter only, no user to content copying, synchronous presentation) may be communicated to mobile device B, and at step 452, an invitation with parameters may be communicated to mobile device C. In one embodiment, the parameters may be the same to each of the mobile devices B and C. Alternatively, different parameters may be sent to each of the mobile devices B and C, if, for example, the user of mobile device A knows the user of mobile device B, but not the user of mobile device C and wants to provide user content copying privileges for the user of mobile device B, but not for the user of mobile device C. In response to the invitations, the users of mobile devices B and C may accept the invitations at step 454 and 456, respectively.

At step 458, the user of mobile device A may communicate group sharing data to each of mobile devices B and C using a local communications protocol, such as Bluetooth, WiFi, or any other local communications protocol. At step 458, the user of mobile device A may send group sharing data to each of mobile devices B and C, as each are now operating in a group mode as created by the sharing user content apps on each of mobile devices A, B, and C. At step 460, the user of mobile device A may alter the group sharing data. For example, the altering of the group sharing data may include zooming in, zooming out, editing, changing images, playing video, editing video or any other altering of group sharing data or user content, as understood in the art. At step 462, in response to the user of mobile device A altering the group sharing data at step 460, the mobile device A may cause the group sharing data or user content on each of mobile devices B and C being displayed to be substantially synchronized in terms of the altering occurring. That is, mobile device A may operate as a master with mobile devices B and C operating as slaves. And, because the mobile devices may communicate directly (i.e., not via a switched communications network, synchronicity may operate with less latency than the configuration of FIG. 4A). In one embodiment, at step 464, the mobile device B, based on the parameters originally established at step 450, may enable the user to store the group sharing data on mobile device B.

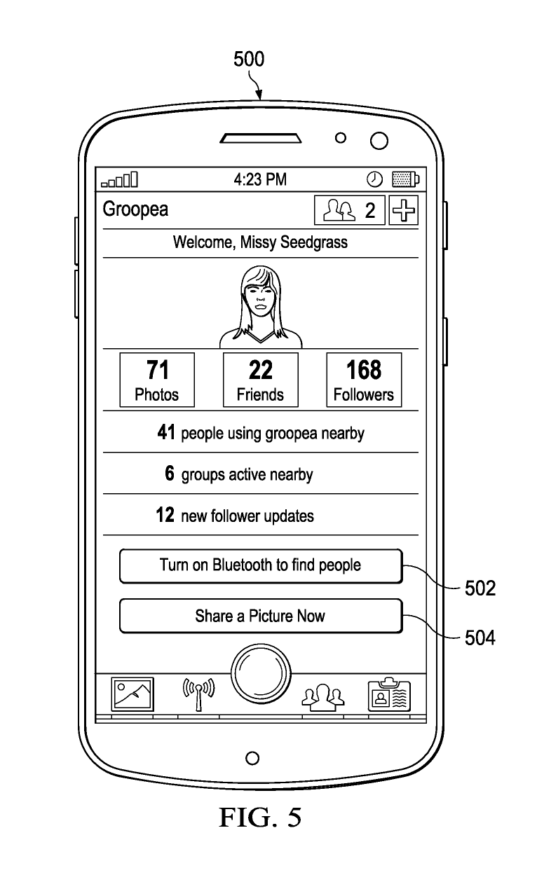

With regard to FIG. 5, a screen shot of an illustrative graphical user interface (GUI) 500 that lists a number of items, including number of photographs, number of friends, number of followers, number of local users, number of local active groups, number of new follower updates, and so forth. In addition, in one embodiment, a soft-button 502 may enable a user to turn on a local wireless communications protocol, such as Bluetooth, to find local users of the sharing user content app, which, in this case, is named Groopea™. In addition, another soft-button 504 may be available for the user to select to share a picture or other user content, as described herein. It should be understood that the principles of the present invention may be configured within an app executed by the mobile device or via an application that is executable via a browser being executed on the mobile device.

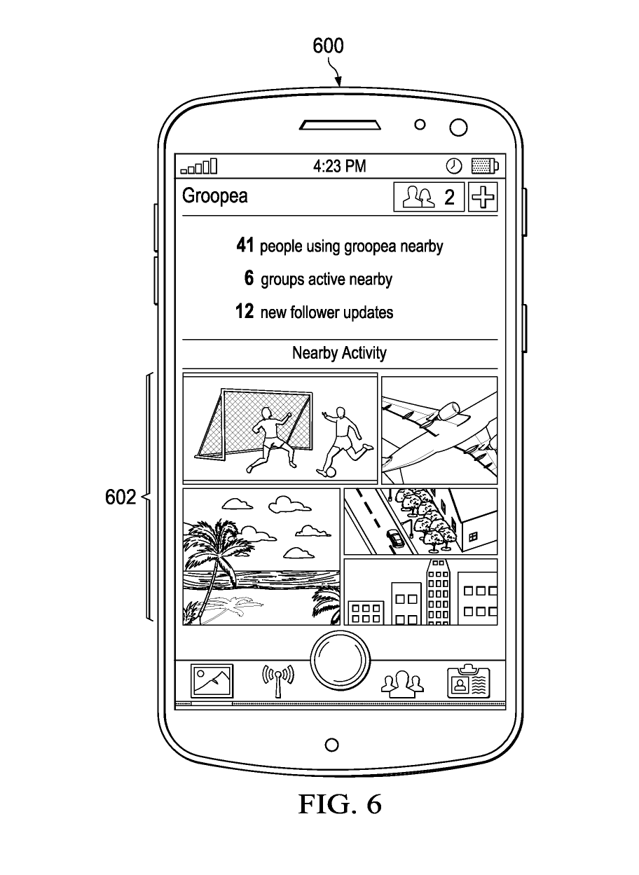

With regard to FIG. 6, a screen shot of an illustrative GUI 600 showing photographs 602 of nearby activity currently happening. The “nearby activity” photographs 602 may be photographs of images currently being displayed in local groups that are being uploaded, shared, or otherwise. In one embodiment, the photographs 602 may be authorized for displaying to other users, optionally limited to approved other users, of the sharing user content app. In such a configuration, the users of the sharing user content app communicate the user content via a server located on a network, as shown in FIG. 2A.

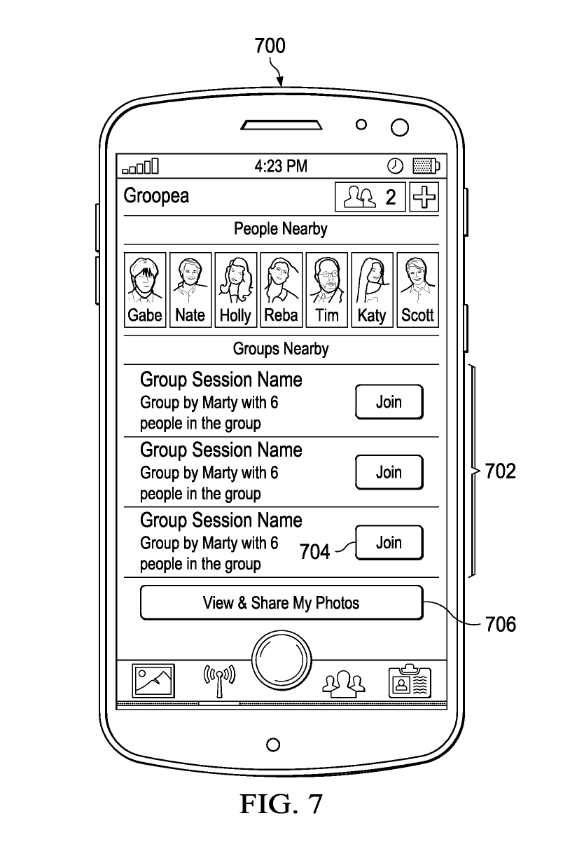

With regard to FIG. 7, a screen shot of an illustrative GUI 700 is shown to include a listing 702 of a number of groups that are currently operating. In one embodiment, a “master” or originator of a group may “publish” the identity or name of the group, which may or may not include the name or alias of the originator, to enable other local users, optionally limited to a friends list or selectable local user list, to join the group. Associated with each of the groups, “join” soft-buttons 704 may be available for selection by a user. In response to a user selectively requesting to join a group session and being accepted into the group by the originator and/or presenter of the group, the mobile device may be joined in the group to view user content being shared by a presenter, as previously described. Such a join feature is an alternative to an invite feature from a presenter. A soft-button 706 may enable the user to freely share his or her photos located on the mobile device.

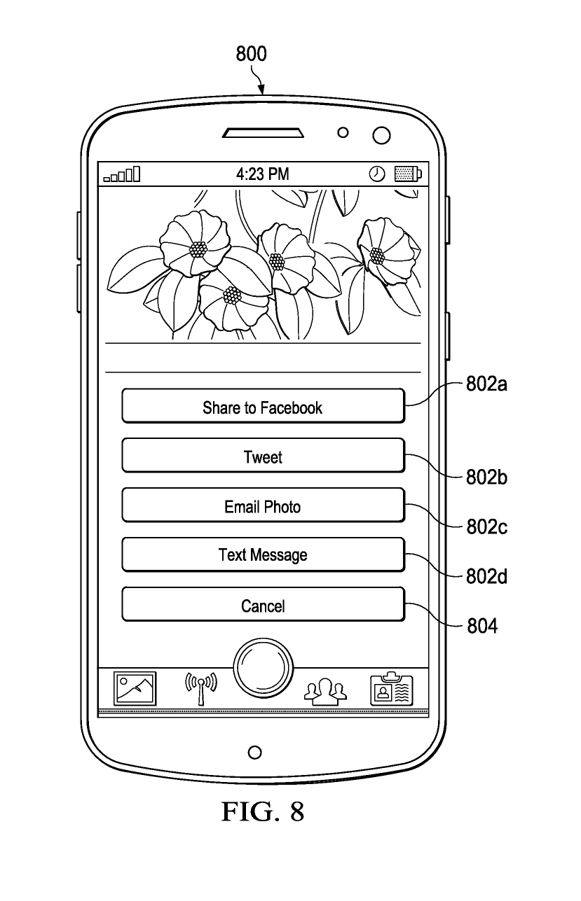

With regard to FIG. 8, a screen shot of an illustrative GUI 800 may enable the user of the sharing user content app to communicate user content. As shown, the GUI 800 may include soft-buttons 802a-802d to enable a user to share user content with a Facebook™ account, tweet user content, e-mail user content, and message user content, respectively. It should be understood that any other type of communication of user content may be utilized in accordance with the principles of the present invention. A “cancel” soft-button 804 may also be available for a user to exit the GUI 800.

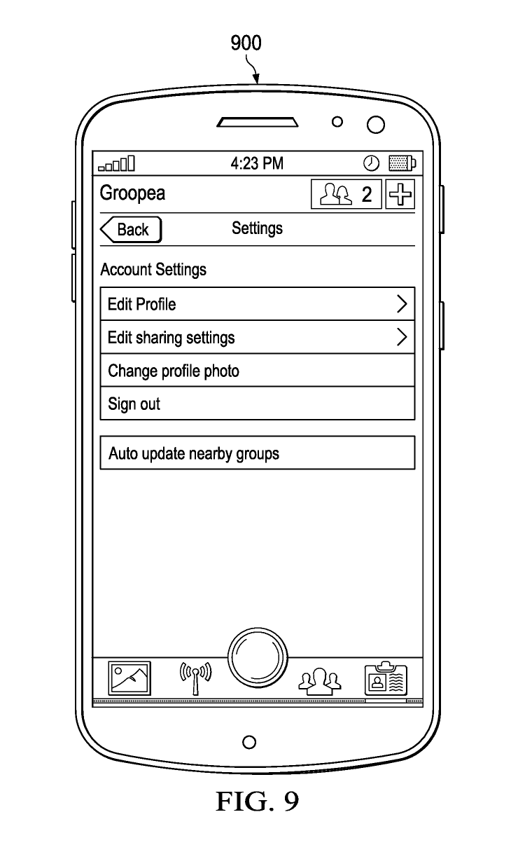

With regard to FIG. 9, a screen shot of a GUI 900 to enable a user to create or modify settings of his or her sharing user content app account is shown. The GUI 900 provides for a user to edit his or her profile (e.g., name, demographics, alias, etc.), edit sharing settings, change profile image or photograph, sign out, set up updates for nearby groups either automatically, semi-automatically, or manually, and so forth. In one embodiment, the settings may enable a user to set up a default setting, whereby a user may automatically set up whether his or her group is to be limited to presenter and viewers preventing viewers from becoming presenters, allowing viewers to become presenters, creating automatic or manual invites, and so forth.

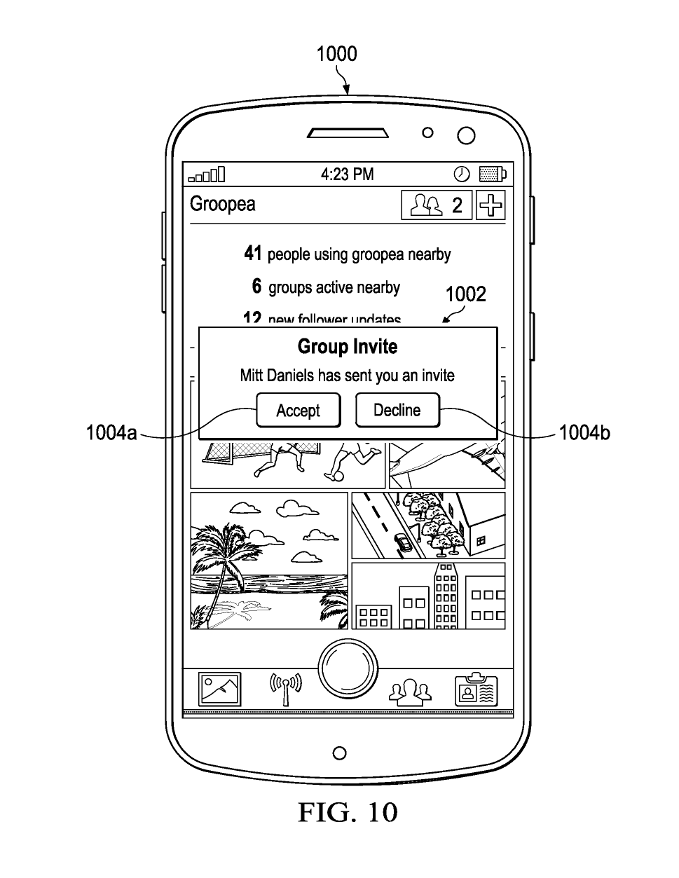

With regard to FIG. 10, a screen shot of an illustrative GUI 1000 is shown to be displaying an invitation request message box 1002 that indicates that a particular user, either actual or alias name, has sent an invite to the user of the mobile device on which the GUI 1000 is being displayed. Two soft-buttons 1004a and 1004b enable the user to accept or decline, respectively, the invitation. In response to the user accepting the invitation, the user is entered into a group that is actively being conducted and may view user content that is actively being presented by a presenter who invited the user to participate in the group.

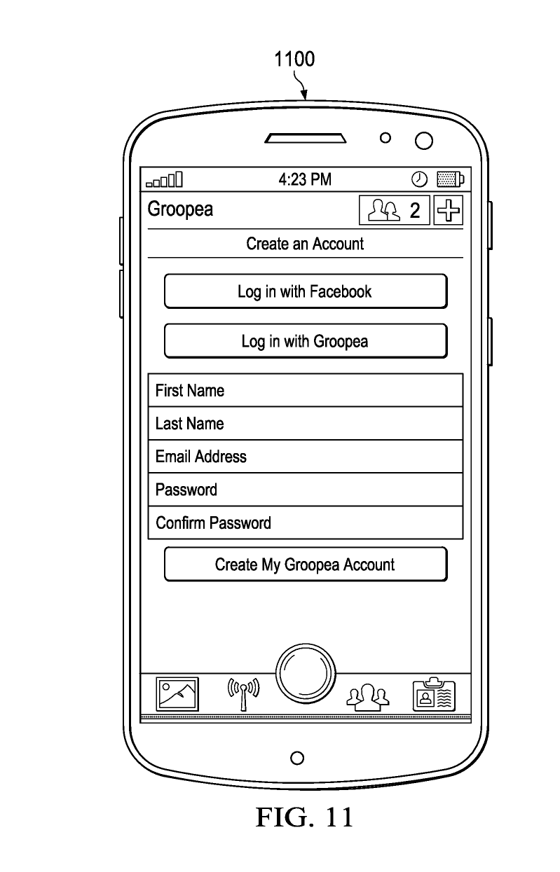

With regard to FIG. 11, a screen shot of an illustrative GUI 1100 is shown that enables a user to create an account on the sharing user content app system, including adding a name, e-mail address, password, and so forth. In addition, the user may also be able to log into his or her account via Facebook™, or other social media network, as understood in the art.

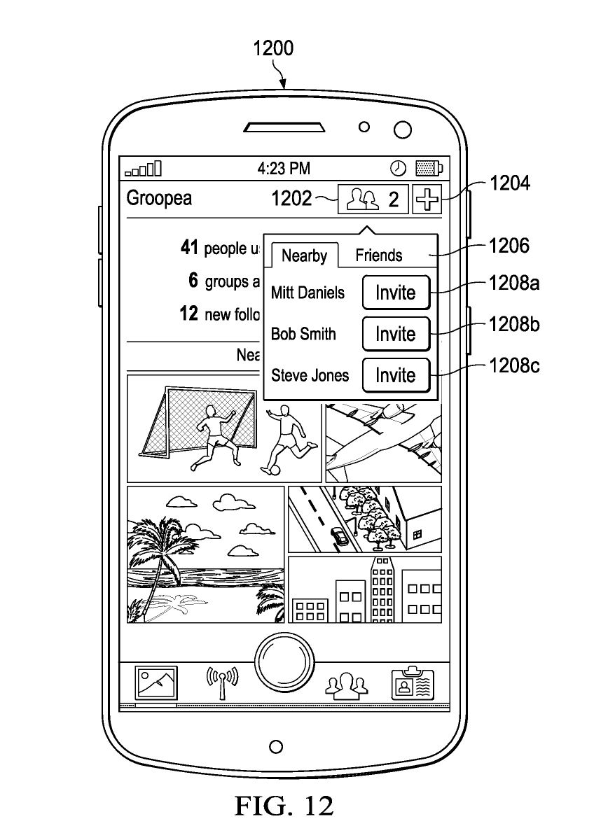

With regard to FIG. 12, a screen shot of an illustrative GUI 1200 is shown to be displaying a pop-up window in which a number of local users or friends may be listed in a data field 1202 and a soft-button 1204 that enables a user to add nearby friends to a group or session. In response to the user selecting the soft-button 1204, a pop-up window 1206 may be displayed that enables a user to select nearby users, who may or may not be known to the user of the mobile device, and/or friends who are local or not local to the user depending upon whether the user is using a local communications protocol for performing the user content sharing or is communicating the user content via a network, such as the Internet. The window 1206 may list a number of local individuals (i.e., mobile devices that are within a range of a local communications protocol of the mobile device of the user), and may list soft-buttons 1208a, 1208b and 1208c associated with each of the different local or nearby users of the sharing user content app, for photo sharing and/or access purposes.

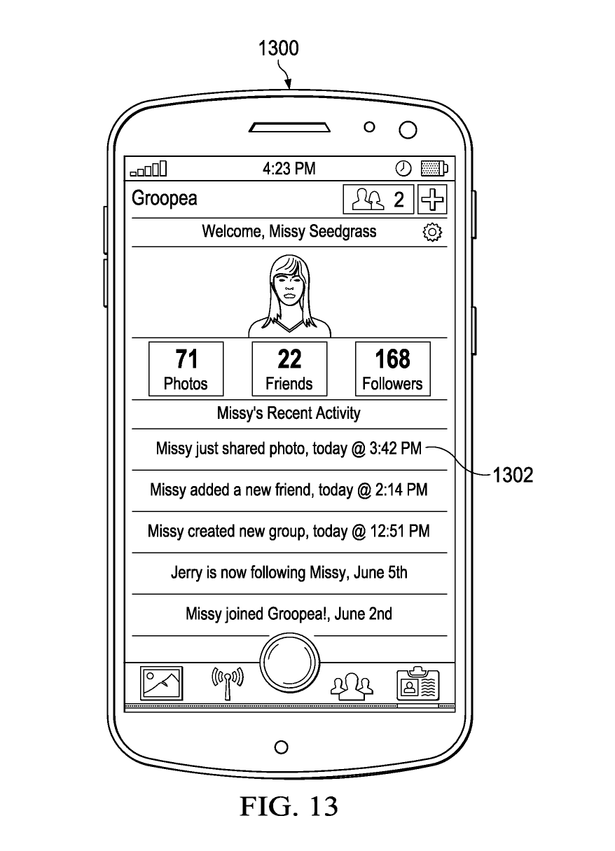

With regard to FIG. 13, a screen shot of an illustrative GUI 1300 is shown to list a recent activity report 1302 of the sharing user content app. In addition, the screen shot 1300 also lists a number of photos that the user has on the sharing user content app, number of friends, and number of followers.

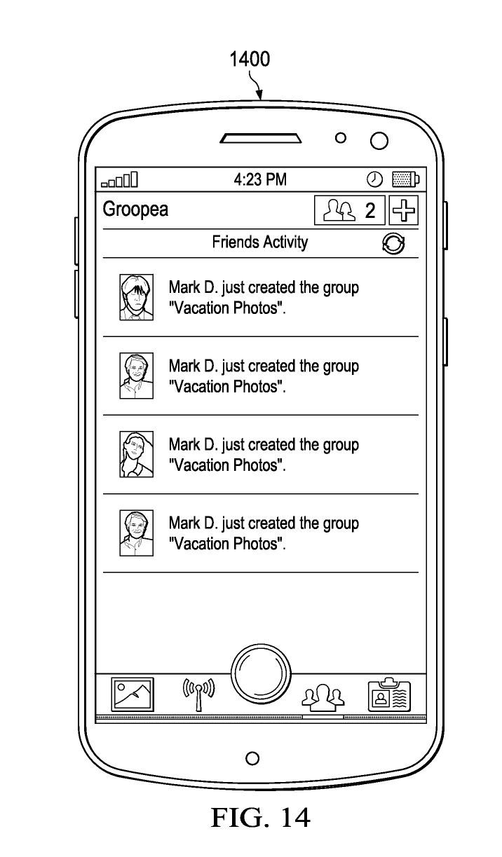

With regard to FIG. 14, a screen shot of an illustrative GUI 1400 may list activities of friends of the user of the sharing user content app. As shown, the listing of the activities of friends includes listing of groups that each of the friends has recently created. In one embodiment, the friends may include photos of each of the friends. The listing may also include geographic location, number of participants of a group, and so forth to provide additional information to the user of his or her friend(s) activities.

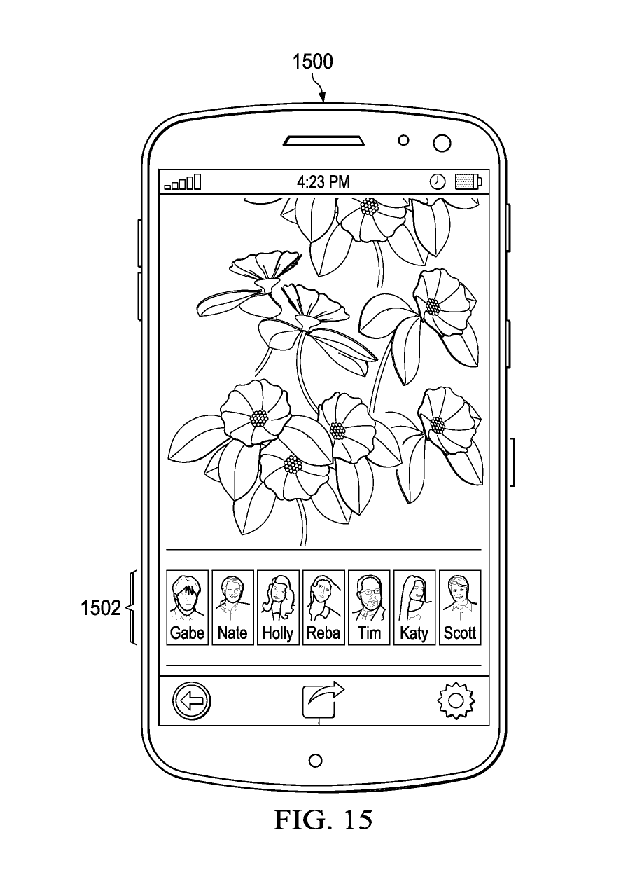

With regard to FIG. 15, a screen shot of an illustrative GUI 1500 may show a listing of friends 1502, local users, or otherwise that may be selectable so that the user may invite or view user content of each of the users listed. It should be understood that a variety of different techniques may be utilized to enable a user to invite or view content of other users of the sharing user content app.

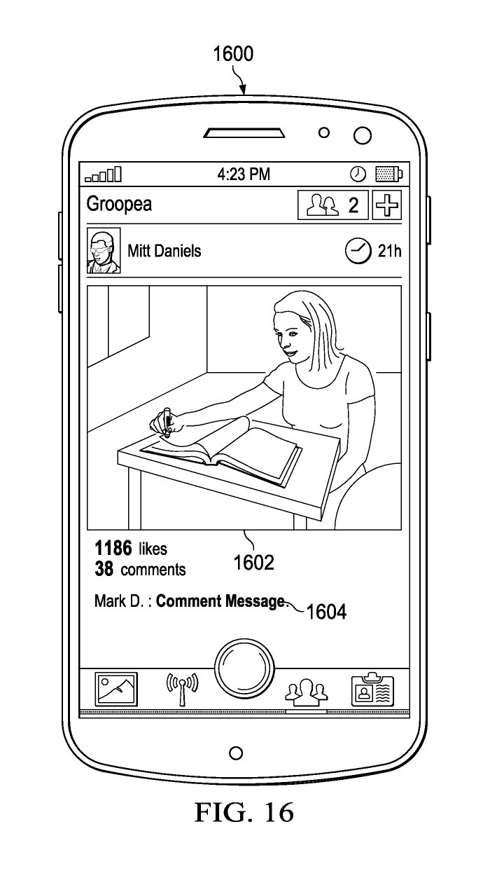

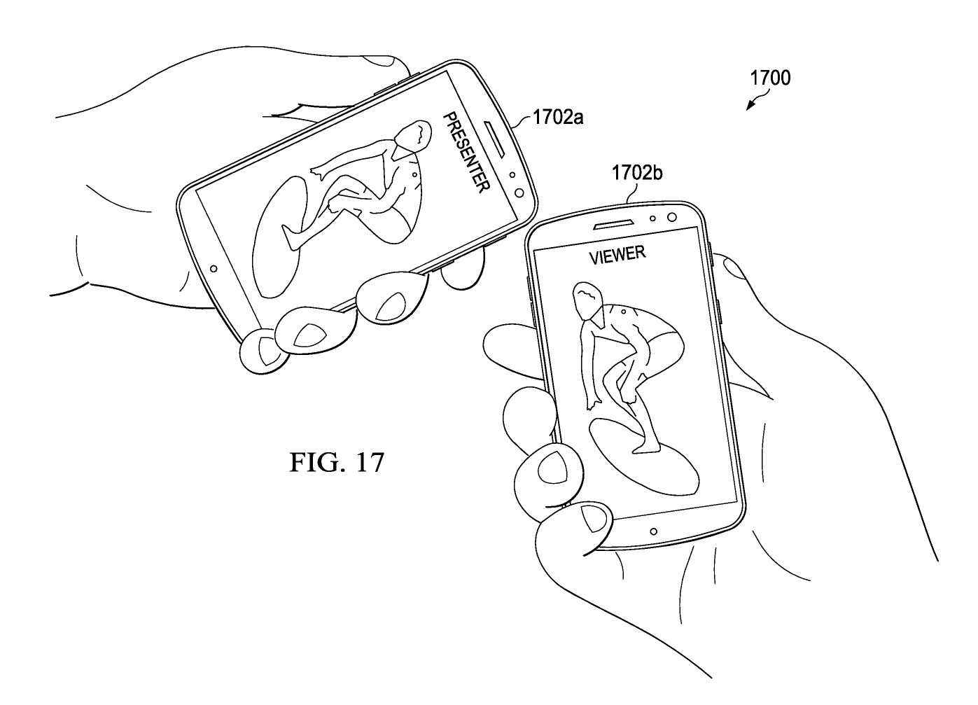

With regard to FIG. 16, a screen shot of an illustrative GUI 1600 may enable a user to view user content of another user, such as in a viewer mode, and list a number of likes and comments about the user content. As shown, the user content is a photograph 1602 and the user, in this case Mark D, may be enabled to enter a message in a text entry field 1604 about the user content.

With regard to FIG. 17, an illustrative environment 1700 is showing two mobile devices 1702a and 1702b in which the devices are being placed close to one another to cause a communications link to occur. In this embodiment, mobile device 1702a is established as the presenter and mobile device 1702b is established as the viewer. By placing the mobile devices 1702a and 1702b close to one another, a Near Field Communications (NFC) communication or “handshake” may occur, as understood in the art. In one embodiment, by using NFC, another form of wireless communications, such as Bluetooth, may be created, thereby enabling the presenter on mobile device 1702a to communicate user data to the mobile device 1702b to enable the viewer to substantially simultaneously view the content that is being displayed on the mobile device 1702a through use of the sharing user content app.

It should be understood that the presenter may be capable of sharing user content that is stored locally on the mobile device or remotely by accessing a remote media storage site, such as Dropbox, Facebook, Instagram, etc. It should further be understood that a group may enable the presenter to present to one or an unlimited number of viewers on an unlimited number and types of mobile devices.

Although the principles of the present invention have been described in terms of the foregoing embodiments, this description has been provided by way of explanation only, and is not intended to be construed as a limitation of the invention. Those skilled in the art will recognize modifications of the principles of the present invention exist. Such modification may include different modules, additional modules, different algorithms, and so forth that provide the same or analogous functionality as described herein.

I claim:

1. A method for a first user to share user content from a first mobile device with a second user of a second mobile device, said method comprising:
inviting, by the first mobile device of the first user, the second user using the second mobile device to communicate with the first mobile device;
in response to receiving an acceptance from the second user of the second mobile device, establishing a communications link between the first and second mobile devices, the first mobile device being established as a presenter and the second mobile device being established as a viewer;
communicating the user content as directed by the first mobile device for substantially synchronously displaying the user content on the second mobile device; and
responsive to the first user altering display of the user content on the first mobile device, substantially synchronously altering display of the user content on the second mobile device.

2. The method according to claim 1, further comprising:
identifying participants of a user content sharing network;
determining whether at least one mobile device of participants is geographically local to the first mobile device based on geographic location of the at least one mobile device relative to the first mobile device;
notifying the first mobile device whether any and which of the at least one mobile device of participants are geographically local to the first user; and
enabling the first user via the first mobile device to select from the geographically local participants to invite, at least one of the geographically local participants being the second user.

3. The method according to claim 1, further comprising enabling, via the first mobile device, the first user to select at least one parameter prior to initiating the invitation from the first mobile device to the second mobile device of the second user to set one or more rules for the communication.

4. The method according to claim 3, wherein enabling the first user to select at least one parameter includes enabling the first user to set a parameter that prevents the second user from downloading or copying the user content onto the second mobile device.

5. The method according to claim 3, wherein the communicating includes communicating the user content via a communications network to a remote computing system for distributing the user content to the second mobile device.

6. The method according to claim 3, wherein enabling the first user to select at least one parameter includes enabling the first user to select at least one parameter that allows the second user to request, via the second mobile device, to be presenter from the first user via the first mobile device.

7. The method according to claim 6, wherein, in response to the second mobile device of the second user communicating a request to the first mobile device of the first user, prompting, by the first mobile device, the first user with the request and, responsive to the first user accepting the request via the first mobile device, causing, by the first mobile device, a message to cause control of the communications for sharing content between the first and second mobile devices to change to the second mobile device.

8. The method according to claim 1, wherein communicating the user content includes communicating the user content stored on the first mobile device.

9. The method according to claim 1, wherein inviting includes inviting from the first mobile device directly to the second mobile device using a local communications protocol.

10. The method according to claim 1, further comprising communicating a query from the second mobile device to the first mobile to request to become the presenter of content on the second mobile device to the first mobile device.

11. A system for a first user to share user content between mobile devices, said system comprising:
a first mobile device of a first user configured to invite a second mobile device of a second user to communicate with the first mobile device, said first mobile device, in response to receiving an acceptance from the second mobile device, being configured to:
establish a communications link between the first and second mobile devices, the first mobile device being established as a presenter and the second mobile device being established as a viewer;
communicate the user content as directed by the first mobile device for substantially synchronously displaying the user content on the second mobile device and, responsive to the first user altering display of the user content on the first mobile device, communicate the altered display to cause the user content on the second mobile device to be substantially synchronously altered.

12. The system according to claim 1, further comprising:
a server in communication with said first mobile device and configured to:
identify participants of a user content sharing network;
determine whether at least one mobile device of participants is geographically local to said first mobile device based on geographic location of the at least one mobile device relative to said first mobile device;
notify said first mobile device whether any and which of the at least one mobile device of participants are geographically local to the first user; and
enable the first user via said first mobile device to select from the geographically local participants to invite, at least one of the geographically local participants being the second user.

13. The system according to claim 11, wherein said first mobile device is further configured to enable the first user to select at least one parameter prior to initiating the invitation to the second mobile device of the second user to set one or more rules for the communication.

14. The system according to claim 13, wherein said first mobile device, in being configured to enable the first user to select at least one parameter, is configured to enable the first user to set a parameter that prevents the second user from downloading or copying the user content onto the second mobile device.

15. The system according to claim 13, further comprising a remote computing system for distributing the user content to the second mobile device.

16. The system according to claim 13, wherein said first mobile device is further configured to enable the first user to select at least one parameter that allows the second user to request, via the second mobile device, to be presenter from the first user via said first mobile device.

17. The system according to claim 16, wherein said first mobile device is further configured to:
prompt, in response to the second mobile device of the second user communicating a request to the first mobile device of the first user, the first user with the request; and
responsive to the first user accepting the request, cause a message to cause control of the communications for sharing content between the first and second mobile devices to change to the second mobile device.

18. The system according to claim 11, wherein the user content is stored on the first mobile device.

19. The system according to claim 11, wherein said first mobile device is configured to directly invite the second mobile device using a local communications protocol.

20. The system according to claim 11, wherein said first mobile device is further configured to receive a query from the second mobile device that requests to become a presenter of content by the second mobile device to said first mobile device.
